(19) United States
(12) Patent Application Publication
(10) Pub. No.: US 2016/0001343 A1
(43) Pub. Date: Jan. 7, 2016

(54) FLOW-TURNED BREAK DISC

(71) Applicant: THYSSENKRUPP STEEL EUROPE AG, Duisburg (DE)

(72) Inventor: Michael GÖVERT, Monheim (DE)

(21) Appl. No.: 14/654,726

(22) PCT Filed: Dec. 17, 2013
(86) PCT No.: PCT/EP2013/076913

§ 371 Date: Sep. 16, 2015

(30) Foreign Application Priority Data
Dec. 20, 2012 (DE) 10 2012 112 823.5

(51) Int. Cl. B21D 22/14; B21D 53/26; F16D 65/12

(52) U.S. Cl. CPC B21D 22/14; F16D 65/12; F16D 65/125; B21D 53/26; F16D 2065/1308

(57) ABSTRACT

The present disclosure relates to a brake disc of a disc brake, comprising a friction ring and a brake-disc chamber. The present disclosure further relates to a method for producing a brake disc, and also to the use of said brake disc. The object, of proposing a brake disc which firstly can be produced in a simple manner, has a weight-saving potential and at the same time can be mass-produced, is achieved in that the friction ring and the brake-disc chamber of the brake disc are one-piece and are composed of a flow-formed, heat-resistant or highly heat-resistant steel grade.

### FIELD

The invention relates to a brake disc of a disc brake, comprising a friction ring and a brake-disc chamber. The invention further relates to a method for producing a brake disc, and also to the use of said brake disc.

### BACKGROUND

Disc brakes are brake systems which are often used in motor vehicles, cranes or elevators. In these cases, the disc brake comprises brake blocks which are usually pressed against the rotating brake disc, so that the rotation movement of the brake disc is braked. To this end, the brake disc comprises a brake-disc chamber which has the shape of a cup and has a friction ring which is fastened to the brake-disc chamber. The brake blocks of the disc brake are pressed against the surfaces of the friction ring. The brake-disc chamber serves to fasten the rotation shaft of which the rotation is intended to be braked. The brake-disc chamber and the friction ring are usually produced from cast steel for use in mass production. Although it is possible to produce highly complex bodies and, respectively, brake discs when using a cast body which is composed of cast steel, the freedom in respect of design is limited by a minimum wall thickness which is necessary for casting the body. As a result, the brake discs which are composed of cast steel are often disadvantageous in respect of weight. In contrast, lightweight solutions are also available, these having, for example, a friction ring which is composed of cast steel and a brake-disc chamber which is composed of aluminum or an aluminum alloy. In addition to the problem of contact between two different metals in these brake discs, the brake-disc chamber also has to be produced separately and in this respect leads to higher costs. Furthermore, the problem of the minimum wall thickness and, in this respect, an increased weight still exists for the friction ring which is produced from cast steel. German laid-open specification DE 10 2009 029 780 A1 discloses a brake disc for a motor vehicle, in which the brake-disc chamber is produced from a flat part by flow-forming and is molded onto the friction ring which is arranged in the spinning mandrel of the flow-forming apparatus. Owing to joining surfaces which are provided in the friction ring, the brake-disc chamber can be connected to the friction ring or to the friction ring arrangement in an interlocking manner. Although both the brake-disc chamber and also the friction ring can be selected to be composed of a different material, so that a lightweight construction is possible, both components are further produced separately and then connected to one another by means of an interlocking connection. Since the friction ring once again comprises a cast structure, the wall thickness of the friction ring is limited to the minimum that is required for casting the friction ring in this case too.

### SUMMARY

Proceeding from the above, the present invention is based on the object of proposing a brake disc which firstly can be produced in a simple manner, has weight-saving potential and at the same time can be mass-produced. Furthermore, a simple production method for a brake disc and also advantageous uses of the brake disc are intended to be proposed.

According to a first teaching of the present invention, the described object in respect of a brake disc is achieved in that the friction ring and the brake-disc chamber of the brake disc are one-piece and are composed of a flow-formed heat-resistant or highly heat-resistant steel grade. Owing to the flow-forming process or the flow-turning process, a highly precise shape of the friction ring and of the brake-disc chamber can be provided from a single piece of metal. Since only a single method step and a single raw material are used, the production method for the brake disc according to the invention is particularly cost-effective. Furthermore, the wall thicknesses can be reduced to the technically required minimum, so that a clear saving in weight is possible. Furthermore, the brake disc according to the invention is not limited to the metals which are suitable for casting, such as specific cast steels, but rather can also be produced from, for example, highly heat-resistant steel alloys or aluminum alloys which cannot be cast.

According to a first embodiment of the brake disc according to the invention, the brake-disc chamber and the friction ring have a wall thickness which is different at least in regions. Flow-forming processes or flow-turning processes permit an enormous degree of flexibility in respect of deformation, so that, for example, the friction ring can have a greater wall thickness than the brake-disc chamber. During the flow-forming process or during the flow-turning process, it is possible for material to accumulate or to form at a different point, so that the optimum thicknesses for the brake-disc chamber and the friction ring can be selected on account of the high degree of flexibility in the shaping of the brake disc, so that an optimum weight is achieved.

The high possibility of shaping when using the flow-forming process or the flow-turning process also allows one-piece brake discs to be provided, these being designed as a double brake disc according to a further embodiment. Double brake discs have two friction rings which comprise two ring surfaces which are arranged in a manner spaced apart from one another. Even complex geometries of this kind are provided in an one-piece manner according to the invention and in this respect do not require any more working steps than the single brake disc.

The brake-disc chamber preferably has means for fastening a rotation shaft and/or the friction ring has means for ventilating the friction ring. The means for fastening the brake-disc chamber to the rotation shaft or else for ventilating the friction ring can be produced in a simple manner by means of the flow-forming process or flow-turning process. However, it is also conceivable for other method steps to be used in order to provide means for fastening the brake-disc chamber and/or means for ventilating the friction ring of the brake disc.

If the friction ring has a coating, different functions can be achieved by way of this coating. For example, given a particularly highly temperature-resistant coating, the material of the friction ring and therefore also of the brake-disc chamber can be selected to be as cost-effective as possible since a high degree of temperature resistance of the surface of the friction ring is already ensured by the coating. As a result, it is possible to use, for example, steel grades which are not as highly resistant to temperature as the material for the friction ring and the brake-disc chamber.

In general, any desired metals can be used, provided that they firstly ensure the requisite plastic deformation during the flow-forming process or the flow-turning process. The brake disc is preferably composed of steel, a highly heat-resistant or heat-resistant steel grade, for example an Fe—Al alloy or an Fe—Al—Cr alloy. Steel has a higher level of heat resistance and in this respect is a preferred material for brake discs which are subject to high temperatures. In particular, Fe—Al steels and Fe—Al—Cr steels are highly heat-resistant and cost-effective, and therefore they are particularly well convenient for brake discs.

According to a second teaching of the present invention, the object described above in respect of a production method for a brake disc is achieved in that the brake disc is produced using a flow-forming process and/or flow-turning process. A flow-forming process or flow-turning process is a highly precise shaping method with which an extremely high degree of shaping flexibility is achieved. In particular, locally changed wall thicknesses can be produced using the flow-forming process or flow-turning process, and therefore an one-piece brake disc, including a brake-disc chamber and a friction ring, can be produced from one blank in a single method step. On account of the high possibility of automation of this production method, brake discs can therefore be completely produced in a cost-effective manner in one working operation.

According to a further embodiment of the method, the brake disk is preferably produced from a flat steel sheet, a circular blank or an extruded tubular blank. It is also conceivable for the blanks to already be pre-shaped or else have means for fastening, for example holes in a spinning mandrel. All precursors of a brake disc share the common feature that they can be produced with a relatively low level of complexity and costs.

If the wall thickness of the flat steel or of the circular blank is at least 4 mm before the flow-turning process or flow-forming process, firstly enough material for forming the brake-disc chamber and the friction ring can be provided. Secondly, it is possible, for example, to avoid a cold-rolling process for providing the flat steel and to provide the flat steel or the circular blank from a hot strip. Costs can likewise be saved as a result.

According to a further embodiment of the present invention, a double brake disc is produced using the flow-turning process or flow-forming process. A double brake disc has two friction rings which are arranged parallel in relation to one another and are one-piece with the brake-disc chamber. Since only a single working operation is required for producing the double brake disc, cost saving can also be achieved when producing double disc brakes.

In order to prevent subsequent warping of the produced brake disc under the action of heat, the metal is thermally controlled during the plastic deformation according to a further embodiment of the method. The increase in temperature owing to the shaping of the workpiece which is to be formed is reduced to a minimum by slight or selected/directed cooling. It goes without saying that it is also possible to heat the workpiece which is to be formed in a selective manner, for example by induction or conduction, in order to assist the shaping process. It is advantageous, particularly when steel grades are used, for the produced brake discs to be hardened and annealed after they are produced.

The production of the brake discs using the flow-forming process or flow-turning process is so precise that further machining and ideally even grinding processes for the frictional surfaces can be dispensed with. Therefore, a brake disc which can be immediately used can be provided by way of the flow-forming process or flow-turning process.

According to a further embodiment of the method, at least the surfaces of the friction rings of the brake disc are coated. This coating can be realized on the one hand as a high-temperature coating, so that said coating protects the friction rings themselves. Furthermore, it is also possible to only protect the surface of the friction rings against corrosion by way of the coating, so that the coating is removed by the first braking processes when the brake disc is used. It is also conceivable, in principle, to coat the brake-disc chamber in order to either make said brake-disc chamber attractive or else to protect said brake-disc chamber against corrosion.

Since the brake disc according to the invention has a great deal of potential in respect of savings in weight and can be produced in a simple manner at low cost, the brake disc is preferably used in motor vehicles or rail vehicles, cranes and elevators.

### DETAILED DESCRIPTION OF THE FIGURES

The invention will be explained in greater detail below with reference to exemplary embodiments in conjunction with the drawing, in which

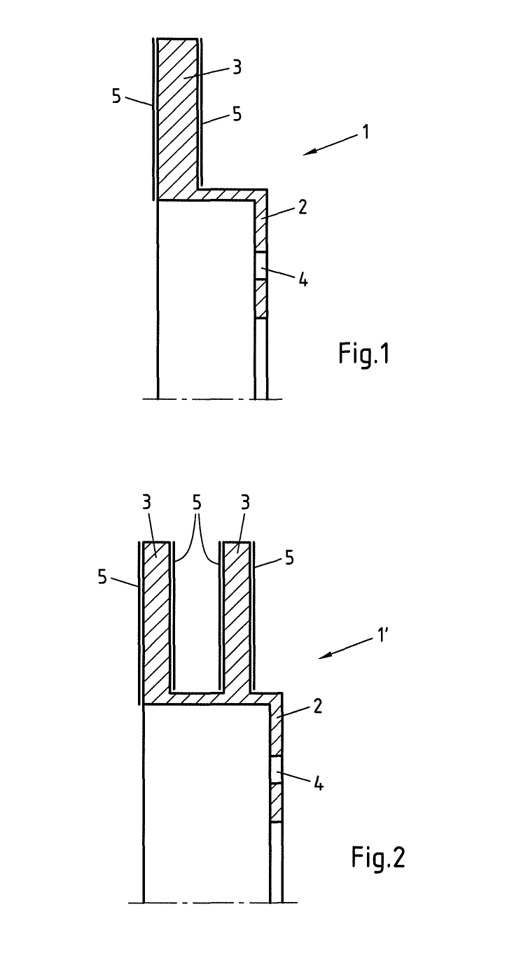

FIG. 1 shows half of a sectional view through a first exemplary embodiment of a brake disc,

FIG. 2 shows a sectional view through a further exemplary embodiment of a brake disc,

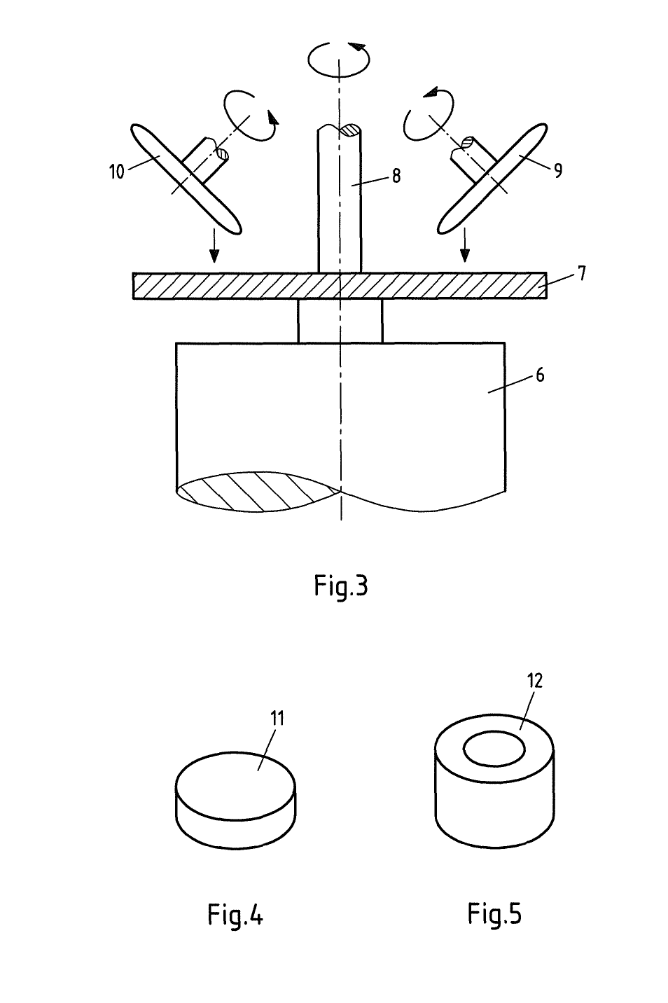

FIG. 3 shows a schematic sectional view through an apparatus for carrying out the production method according to the invention, and

FIGS. 4 and 5 show different forms of blanks for carrying out the method according to the invention.

### DETAILED DESCRIPTION

FIG. 1 shows half of a sectional view through an exemplary embodiment of a brake disc according to the invention. The brake disc 1 comprises a brake-disc chamber 2 and a friction ring 3. During braking processes, the friction ring 3 establishes contact with brake blocks, not illustrated, so that the rotation of the brake disc 1 is braked by means of friction on the friction ring 3. According to the invention, the brake-disc chamber 2 and the friction ring 3 are one-piece designed from a flow-formed metal. This results in the substantial advantage that, firstly, the connection between the friction ring and the brake-disc chamber has a maximum strength. Secondly, on account of the flow-forming process or flow-turning process, it is possible to use a material other than cast materials for producing the brake disc, so that considerably lower wall thicknesses are also possible. In addition to this, a further result is the advantage over other lightweight solutions that, on account of the one-piece design of the brake disc 1, corrosion problems in respect of the combination of different materials no longer play any role. The flow-formed metal can additionally have a means 4 for fastening the brake disc on a rotating shaft or else on the spinning mandrel, which is used to produce the brake disc. As can be seen in FIG. 1, the friction ring 3 has a larger wall thickness than the brake-disc chamber 2. This is achieved by the flow-forming process and/or flow-turning process being able to plastically deform the material to a great extent in such a way that the accumulation of material or thinning can be provided in a simple manner. Furthermore, the brake disc 1 according to the invention can be produced in a highly precise manner by the use of the flow-forming process or flow-turning process, so that grinding processes or machining processes on the brake disc 1 after the working operation of the flow-turning process or flow-forming process are generally no longer required.

Owing to the selection of the flow-formed metal, it is possible to not only use cast materials for producing brake discs 1. The brake disc according to the invention can also be produced, for example, from steel grades which have not been usable for constructing the brake discs up until now, for example grades which are composed of Fe—Al—Cr alloys. In addition, FIG. 1 shows a coating 5 which is preferably provided on both sides of the friction ring 3. Said coating can serve to protect the friction ring 3 against corrosion or similar influences, in order to then be removed during the first braking processes. Secondly, the coating 5 can also be highly temperature-resistant and friction-resistant, and therefore said coating is used to provide the braking action. In this case, the material used for the brake disc, for example the steel grades, which does not have a high temperature resistance, therefore relatively cost-effective steel grades can be used for example.

FIG. 2 shows a next exemplary embodiment in a sectional view through half of a brake disc 1′ according to the invention which is in the form of a double brake disc. The double brake disc of FIG. 2 has two friction rings 3 which are arranged in parallel and which likewise have a coating 5 which is arranged on both sides. The brake disc illustrated in FIG. 2 is furthermore likewise of one-piece design.

FIG. 3 shows an exemplary embodiment of an apparatus with which the method according to the invention can be carried out or a brake disc according to the invention can be produced. The known apparatus for carrying out the flow-forming process has a spinning mandrel 6 which has the shape of the brake disc together with the brake-disc chamber and the friction ring. The extruded blank 7 is pushed onto the spinning mandrel 6 by means of holding means 8, and the entire apparatus is rotated. The indicated pressure rollers 9, 10 can then deform the blank 7 by a flow-turning process or flow-forming process in such a way that said blank has, for example, the form of the brake disc 1 illustrated in FIG. 1. In the process, the rotating pressure rollers can plastically deform the material and achieve very high degrees of deformation. Additional means for heating and/or cooling the regions which are intended to be flow-formed can be provided and serve, owing to the temperature control, to prevent warping of the brake disc under the action of temperature. Owing to the thermal control, stresses which are introduced into the material by the deformation are reduced, and therefore the brake disc can be provided with a low level of stress, for example by means of conductive heating which can be integrated within the spinning mandrel (not illustrated here).

Finally, FIG. 4 and FIG. 5 show, in perspective illustrations, two different blanks 11, 12 which can be used for the method according to the invention for producing a brake disc comprising a brake-disc chamber and a friction ring. The circular blank 11 and the extruded blank 12 can be produced as mass-produced products in a simple manner and serve as cost-effective starting products for producing the brake disc 1 according to the invention. As already stated, owing to the use of the method according to the invention, it is possible not only to produce brake discs from materials which have not been previously known, but, in particular, to also considerably reduce the costs of the production method.

1. A brake disc of a disc brake, comprising a brake-disc chamber and a friction ring, characterized in that the friction ring and the brake-disc chamber of the brake disc are one-piece and are composed of a flow-formed heat-resistant or highly heat-resistant steel grade.

2. The brake disc as claimed in claim 1, characterized in that the brake-disc chamber and the friction ring have wall thicknesses which are different at least in regions.

3. The brake disc as claimed in claim 1, characterized in that the brake disc has two friction rings.

4. The brake disc as claimed in claim 1, characterized in that the brake-disc chamber has means for fastening a rotation shaft and/or the friction ring has means for ventilating the friction ring.

5. The brake disc as claimed in claim 1, characterized in that the friction ring has a coating.

6. The brake disk as claimed in claim 1, characterized in that the brake disc is composed of steel, an FeAl alloy or an FeAlCr alloy.

7. The brake disc as claimed in claim 1, characterized in that at least the friction ring has a highly temperature-resistant coating.

8. A method for producing a brake disc which has a brake-disc chamber and a friction ring, characterized in that producing the brake disc using at least one of a flow-forming process and flow-turning process.

9. The method as claimed in claim 8, characterized in that the brake disc is produced from a flat steel sheet, a circular blank or an extruded tubular blank.

10. The method as claimed in claim 8, characterized in that the thickness of the flat steel or of the circular blank is at least 4 mm before the flow-turning process or flow-forming process.

11. The method as claimed in claim 8, characterized in that a double brake disc (1′) is produced using the flow-turning process or flow-forming process.

12. The method as claimed in claim 8, characterized in that the metal is thermally controlled during the plastic deformation.

13. The method of claim 8, characterized in that at least the surfaces of the friction rings are coated.

14. (canceled)
